(19) United States
(12) Patent Application Publication
(10) Pub. No.: US 2018/0352883 A1
(43) Pub. Date: Dec. 13, 2018

(54) UPPER BODY GARMENT

(71) Applicants: W. L. Gore & Associates GmbH, Putzbrunn (DE); W. L. Gore & Associates, Inc., Newark, DE (US)

(72) Inventors: Guenther Schlee, Wielenbach (DE); William Daniel Kelsey, Elkton, MD (US)

(21) Appl. No.: 15/775,603

(22) PCT Filed: Nov. 16, 2015
(86) PCT No.: PCT/EP2015/076660

§ 371 Date: May 11, 2018

(51) Int. Cl. A41D 31/02; A41D 27/28; A41D 27/10; A41D 27/24; A41D 3/04; B32B 7/12; B32B 5/02; B32B 27/36; B32B 27/12; B32B 27/32; B32B 27/08

(52) U.S. Cl. CPC A41D 31/02; B32B 2255/26; A41D 27/10; A41D 27/245; A41D 3/04; B32B 7/12; B32B 5/024; B32B 27/36; B32B 27/12; B32B 27/322; B32B 27/08; A41D 2300/22; A41D 2300/52; A41D 2400/20; A41D 2400/22; B32B 2307/724; B32B 2437/00; B32B 2255/10; B32B 2250/246; A41D 27/28

(57) ABSTRACT

Disclosed is a water vapor permeable upper body garment (10) having a front side and a back side, said upper body garment (10) having the configuration of a single shell garment formed by an outer shell laminate, said outer shell laminate formed at least partly by a stretchable functional laminate; said stretchable functional laminate comprising a first functional film layer and a first textile layer attached to the first functional film layer, said stretchable laminate having a stretch force at 20% elongation of less than 1 N per cm of width; said stretchable functional laminate covering at least an upper central portion on the back side (12) of the upper body garment (10).

The present invention relates to a water vapor permeable upper body garment.

Protective clothing articles are used for wear in wet conditions (such as rain, snow, etc.), in outdoor activities (such as skiing, biking, hiking, etc.) and should protect the wearer by preventing leakage of water or other fluids into the article while keeping the wearer comfortable by allowing perspiration to evaporate from the wearer to the outside of the article. In addition, such an article should maintain the functional attributes of protection and comfort during ordinary use.

Elastic or stretchable fabric laminates may help to improve flexibility of movement. As one example, U.S. Pat. No. 7,930,767 suggests to create body form-fitting rainwear using a waterproof and water vapor permeable laminate having elastic characteristics. The elastic characteristics are provided by coupling a water vapor permeable and waterproof laminate (e.g. GORE-TEX® XCR® three layer laminate) to an additional stretchable knit. The elastic laminate is suggested to form two side panels arranged on the lateral sides of the body.

Where flexibility of movement is essential, elastic or stretchable fabric laminates with the above functional attributes are desired along with soft and drape able feeling. Such elastic fabric laminates are increasingly being used to make protective clothing articles which are form-fitting since the elastic properties of the material allow for a closer fit. However, it is important not to adversely affect the wearer's comfort. The direction or directions of elasticity, the amount of elasticity at a given force and its recovery are all important properties that determine comfort of form-fitting articles of protective clothing as well as the method and ease of manufacturing them. The precise magnitude and balance of these properties in an elastic fabric material, however, depend on each specific end use.

A variety of attempts have been made to improve elastic, breathable laminated and composite fabrics. Although, improvements have been made, many of these fabrics obtain varying degrees of waterproofness, breathability, elasticity, elastic-recovery, and comfort. Further, many fabrics may sacrifice one or more qualities to improve upon other qualities.

Thus, there remains a need for a composite that achieves a high degree of waterproofness, breathability, elasticity, elastic-recovery, and comfort by in use within a variety of applications.

Embodiments disclosed herein provide for an improved approach towards garment closer fitting the body without adversely affecting the wearer's comfort. A water vapor permeable upper body garment has a front side and a back side. The upper body garment has the configuration of a single shell garment formed by an outer shell laminate. The outer shell laminate is formed at least partly by a stretchable functional laminate. The stretchable functional laminate comprises a first functional film layer and a first textile layer attached to the first functional film layer. The stretchable laminate having a stretch force at 20% elongation of less than 1 N per cm of width. The stretchable functional laminate covers at least an upper central portion on the back side of the upper body garment.

Examples of an upper body garment as suggested above may be a jacket, a vest, a sweater, a shirt, etc. Such upper body garment comprises a front side usually covering the front of a body, and a back side covering the back of a body. The front side and the back side may be connected by side panels, or they may be connected directly to each other thus also covering side parts of the body.

As used herein, the term functional laminate means an article comprising a functional layer, film, or coating that is coated onto or adhered to at least one layer of textile. The functional layer, film, or coating has water vapor permeable characteristics. In particular embodiments, the functional layer, film, or coating may have water vapor permeable and waterproof characteristics. The water vapor permeable and waterproof functional layer may have the configuration of a laminate made up with a water vapor permeable and waterproof membrane and a textile layer attached to the water vapor permeable and waterproof membrane.

Such laminates are principally known in the art, e.g. from U.S. Pat. No. 5,804,011 which discloses a fabrics being stretchable in two dimensions. The textile layer may have an elastic textile configuration, e.g may be made as a knit having an elastic knit pattern (like a tricot, warp knit, or similar knit pattern). In such case the textile need not necessarily include elastic threads to provide the desired elastic characteristics. However, in a number of configurations, it may be helpful if the textile layer comprises elastic filaments, e.g. made from elasthane to further enhance the elasticity of the textile layer.

The water vapor permeable and waterproof functional layer may include a water vapor permeable and waterproof membrane. The membrane may be selected from polyurethane, polyester, polyether, polyamide, polyacrylate, copolyether ester and copolyether amides, as well as other suitable thermoplastic and elastomeric films. In an aspect of the invention the waterproof, water vapor permeable membrane may be made of a fluoropolymer, particularly made of microporous expanded polyterafluorethylene (ePTFE). The microporous polytetrafluoroethylene membrane is a membrane of expanded polytetrafluoroethylene as taught in U.S. Pat. Nos. 3,953,566 and 4,187,390, to Gore. Such membranes of expanded polytetrafluoroethylene are present in commercially available laminates from W. L. Gore and Associates, Inc., Elkton, Md., for example under the tradename GORE-TEX® fabric. The water vapor permeable and waterproof functional layer may comprises additional coatings or treatments. In one embodiment the water vapor permeable and waterproof functional layer may be composed of a polyurethane coated microporous expanded polytetrafluoroethylene membrane made substantially according to the teachings of U.S. Pat. No. 4,194,041 and U.S. Pat. No. 4,942,214 assigned to W.L. Gore and Associates, Inc, in Elkton, Md.

Moreover, the terms functional film, functional layer, and functional coating are meant to denote a substance that provides properties of a barrier. These properties may include, but are not limited to: a barrier to liquid (e.g., water) penetration, a barrier to penetration by chemical substances, a barrier to gas penetration, a barrier to particulate penetration, a barrier to air penetration (e.g., impermeability), odor control, antimicrobial, windproof, and breathability. The terms functional film or functional layer, as used herein are understood in general sense and may include any film or layer of polymeric material, including spun bonded or electrospun non woven membranes (sometimes referred to as “nano membranes”), provided the film or layer provides some barrier characteristics.

As used herein, the term “textile” is meant to denote any woven, nonwoven, felt, knit, stretch spunbond nonwoven, stretch needle punched, nonwoven, stretch spunlace nonwoven, or fleece and can be composed of natural and/or synthetic fiber materials and/or other fibers or flocking materials that has at least some elastic properties.

In particular embodiments, the upper body garment may be water vapor permeable and waterproof.

As used herein, a layer is considered “liquid-proof” if it prevents liquid penetration against a pressure of at least 0.07 bar for a duration of at least 3 minutes. In case the liquid is water, the layer is called water-proof. The water penetration pressure is measured on a water-proof panel based on the same conditions described with respect to the Suter Test for Liquid-proof Fabrics described herein.

The term waterproof garment as used herein is meant to define a garment that meets the Rain tower testing as described herein.

The term waterproof laminate as used herein is meant to define a laminate that meets the Suter test for Liquid-proof Fabrics as described herein.

The term single shell garment as used herein is meant to describe a garment made of one material piece, or made of more material pieces or panels attached to each other such as to form the single shell. Each material piece or panel has the configuration of a single layer composite. A single shell garment is comprised of one or more material layers combined to form a single piece of garment, e.g. jacket, vest, sweater. In case the single shell is composed of more than one material layer, those material layers will be bonded together to form a functional laminate. Bonding as used herein is intended to cover all types of bonding two layers together in a manner resulting in a water vapor permeable laminate. Typically, in the field of functional laminates bonding two layer together may be done by applying a discontinuous layer of adhesive, e.g. by applying an adhesive in the form of dots, stripes, or other geometric patterns, or by bonding two layers together using a water vapor permeable adhesive. When using a water vapor permeable adhesive the adhesive may be applied continuously, i.e. as one contiguous film.

An outer shell garment is the outermost garment of a clothing system. The single shell of the garment as disclosed herein comprises one surface forming the outermost surface of the garment and a second surface forming the innermost surface of the garment. Therefore, the single shell forms the outer shell of said garment.

The upper central portion of the back side or front side of the garment is intended to comprise the region between 50% of the total length (measured from the top) and 60% of the total width (measured from the centre) of the back side or of the front side of the upper garment. The upper central portion on the back side is determined with respect to the back side of the upper garment.

The upper garment suggested herein forms a composite of at least one stretchable functional laminate and at least one non-stretchable functional laminate. The stretchable functional laminate may be chosen such as to provide a desired flexibility, and may be arranged such as to cover those portions of the upper garment where most flexibility of the garment is required, while still providing a sufficient level of breathability. In other portions of the upper garment where less flexibility is required, a functional laminate may be used providing a desired breathability. Particularly, a non-stretchable functional laminate may be used in those portions. Particularly, the stretchable functional laminate may form a patch covering a central part of the back side of the upper garment. Extended experiments have shown that most flexibility is required in this part. Since the patch of stretchable laminate itself is highly breathable, a garment can be produced which is both highly elastic, but also highly breathable.

A suitable stretchable functional laminate may comprise a first functional film layer and a first textile layer attached to the first functional film layer by an adhesive layer and may have a stretch force at 20% elongation of less than 0.5 N per cm of width, as set out in BS EN 14704-1:2005. An elongation of 20% means that the material's dimension in the direction of tension is 120% with respect to the original dimension of the material before the tension is applied. A functional laminate fulfilling these requirements and being also water vapor permeable and waterproof is described in WO 2014/151223 A1.

An upper garment as suggested herein allows a highly close fit garment construction combined with low garment restriction force. Therefore, the upper garment may be highly breathable due to the close fit of the functional laminate to the body which minimizes air gaps underneath the upper garment.

The positioning of the stretchable functional laminate at upper central portion on the back side provides for a low garment restriction force, such that despite the close fit of the upper garment flexibility of movement remains excellent and the upper garment provides soft and drape able feeling. The garment remains most comfortable to wear.

Particular embodiments may include any of the following optional features, alone or in combination:

In particular embodiments the stretchable functional laminate may also provide elastic characteristics. The term elastic as used herein is meant to denote that a material has stretch characteristics and can be tensioned to elongate the material;

and, upon release of tension, the material essentially returns to its approximate original dimension. Thus, a functional laminate may be considered elastic in case it has a force to stretch of less than 1 N/cm at 20% elongation according to BS EN 14704-1:2005 with a specimen size of 50×100 mm; and a recovery of at least 95%, measured 1 min after the tension has been released.

A material may be considered highly elastic or having a high elasticity in case such material has stretch characteristics and can be tensioned to at least about 50% elongation (or greater) by a force to stretch of less than 1 N/cm; and, upon the release of tension, it has a recovery of at least 95%, measured 1 min after the tension has been released.

A stretchable or elastic laminate has at least one stretchable or elastic layer. Accordingly, a demonstration of a stretchable layer or an elastic layer within the laminate is sufficient to test for stretchability or elasticity of the laminate. In other words, if the laminate is stretchable or elastic, at least one layer within the laminate is stretchable or elastic.

Particularly, the stretchable functional laminate may cover at least 10% of the surface area of the outer shell of the upper body garment, particularly between 20% and 80%, particularly between 25% and 50%, particularly between 30% and 40%. The surface area of the outer shell is defined by the surface area of the front side, the back side, plus the surface area of any lateral portion, if present in addition to the front side and the back side, plus the surface area of any arm sleeves, if present.

In particular embodiments, it has turned out practical that the stretchable functional laminate comprises a first panel of stretchable functional laminate positioned longitudinally such as to cover the upper central portion on the back side of the upper body garment. The first panel of stretchable functional laminate may cover the spinal column of a person wearing the upper body garment. The first panel of stretchable functional laminate may be positioned symmetrically with respect to the spinal column. For example, the first panel of stretchable functional laminate may have any of an oval shape, a rectangular shape, a triangular shape and a trapezoidal shape.

Particularly, the first panel of stretchable functional laminate may have an elongate shape with a longitudinal axis of the stretchable functional laminate extending along the spinal column. For example, the first panel of stretchable functional laminate may have any of an elongate oval shape, an elongate rectangular shape, an elongate triangular shape and an elongate trapezoidal shape.

As used herein, the terms oval, rectangular, triangular, or trapezoidal do not imply that any of the edges of the stretchable functional laminated define exactly the edges of an ellipse, a rectangle, a triangle, or a trapeze. Rather, these terms are used to express the overall shape or symmetry of the stretchable functional laminate. As an example, it is well conceivable that a stretchable functional laminate of rectangular shape may have one or more curved edges, as long as the shape in general resembles the symmetry of a rectangle.

In embodiments of the water vapor permeable upper body garment, the first panel of stretchable functional laminate may have a longitudinal axis and may be positioned vertically such that the longitudinal axis of the first panel of stretchable functional laminate extends along the spinal column of a person wearing the upper body garment.

Particularly, the stretchable functional laminate may have at least one main direction of stretchability. In case the stretchable functional laminate has two or more directions of stretchability, a main direction of stretchability may be defined by the direction in which stretchability is largest. Then, embodiments are conceivable in which the stretchable functional laminate of the first panel has its main direction of stretchability oriented in horizontal direction, i.e. transverse to the extension of the spinal column. In case of an elongate first panel of stretchable functional laminate extending along the spinal column, the main direction of stretchability may be transverse to the longitudinal direction of the first panel.

Particularly, the first panel of stretchable functional laminate may be connected to a further functional laminate by a waterproof seam. The further functional laminate may selected such as to provide a desired breathability. While the first panel should be made of a functional laminate that is both stretchable and breathable, the further functional laminate not necessarily needs to be as stretchable as the functional laminate of the first panel. In particular, the further functional laminate may be non-stretchable. This allows to select the further laminate such as to optimize breathability. Particularly, the further laminate may be arranged in portions of the garment where less stretchability is required. The term seam or seamed as used herein is meant to include the joining of two portions, regions, or panels of material. A seam may join similar or identical materials or two or more dissimilar materials (e.g. dissimilar laminate panels or pieces of a garment). The terms seam and seamed are not intended to be limited to stitching and/or sewing. Seam and seamed as used herein are meant to include any suitable means of joining two portions regions, or materials, such as by adhesives, bonding, welding, laminating, and the like.

Further, the first panel of stretchable functional laminate may extend over at least 50% of the total length of the back side of the upper garment, measured from the top of the back side of the upper garment downwards (i.e parallel to the spinal column). Moreover, the first panel of stretchable functional laminate may extend over at least 25% of the total width of the back side of the upper garment. The width may be measured from the centre of the back side, then the stretchable functional laminate will extend from the centre to 12.5% of the width of the back side of the upper garment towards each side in lateral direction.

Particularly, the first panel of stretchable functional laminate may cover between 25 and 35% of the area of the back side of the upper body garment. The centre of the first panel may be located at around 25% of the length of the back side of the upper body garment, starting from the top side of the back side. Moreover, the centre of the stretchable functional laminate may be located at 50% of the width of the back side of the upper body garment. The length of the first panel may be between 50% and 70% of the total length of the back side of the upper body garment, measured starting from the top of the back side downwards. The width of the first panel may be between 25% and 35% of the total width of the back side of the upper body garment, symmetrical to the centre of the back side in lateral direction.

Particularly, the first panel may cover between 5% and 50% of the surface area of the outer shell of the upper body garment, particularly between 10% and 35%, particularly between 15% and 25%.

In particular embodiments, the stretchable functional laminate may comprise the first panel covering the upper central portion on the back side of the upper body garment, and at least a second panel covering respective lateral portions of the upper body garment connecting the front side and the back side. In embodiments where the upper body garment includes two arm portions, the second panels may be located below the arm pit of each of the arm portions.

Particularly, the water vapor permeable upper body garment as set out herein may have the configuration of a close fit garment. A close fitting garment as described herein relates to a garment construction where the garment material lays on the skin of the wearer, substantially without an air layer and/or air gaps between the garment material and the skin. The term “on” as used herein is meant to denote that when an element is “on” another element, it can be directly on the other element or intervening elements may also be present.

A close fit garment is an outer shell garment with reduced dimensions compared to a regular fit garment, and, therefore, located closer to the body. An example of a close fit garment, with respect to the dimensions of a garment size 52, is given in the following table 1:

TABLE 1

| | | | Garment measures | | |
|---|---|---|---|---|---|
| | Body | | Regular | Close | Regular |
| Parameter [cm] | measures | Parameter [cm] | fit | fit | fit |
| Garment size | 52 | Garment size | 52 | 52 | 56 |
| Body height | 180 | Body height | 180 | 180 | 184 |
| ½ chest width | 104 | ½ chest width | 63 | 60 | 67 |
| ½ waist width | 92 | ½ waist width | 59 | 56 | 63 |
| ½ hem width | 108 | ½ hem width | 63 | 60 | 67 |
| Upper arm | 20 | Upper arm width | 26.2 | 25 | 27.3 |
| width | | | | | |
| Sleeve hem | 9 | Sleeve hem width | 15 | 14.8 | 15.5 |
| width | | | | | |

In particular embodiments, the water vapor permeable upper body garment as described herein may have a garment restriction force as defined herein of 200 N or lower, in particular a garment restriction force of 175 N or lower, in particular a garment restriction force of 150 N or lower. The way of measuring the garment restriction force is set out in detail below. The lower the garment restriction force, the more comfort is provided to the person wearing the garment. In turn, a low garment restriction force allows to provide a closer fit of the garment, which in turn will increase water vapor permeability of the garment.

In most embodiments, the water vapor permeable functional laminate described herein may have a resistance to evaporative heat transfer RET less than of 20 m² Pa/W or lower. The resistance to evaporative heat transfer RET is measured according to the sweating hot plate method or Hohenstein test, as set out in ISO—11092 (1993) In this test a material (fabric or laminate) is placed above a porous (sintered) metal plate. The plate is heated and water is channelled into the metal plate, simulating perspiration. The plate is then kept at a constant temperature. As water vapor passes through the plate and the fabric, it causes evaporative heat loss and therefore more energy is needed to keep the plate at a constant temperature. The RET is the measurement of the resistance to evaporative heat loss. The lower the RET value, the less resistance to moisture transfer and therefore higher breathability.

The Hohenstein test has been modified by applying a sweating torso for measuring cooling power of a personal cooling system to measure the resistance to evaporation of a garment. Details of this test as modified to measure resistance to evaporation of a garment (RE) are set out below under “Measurement of resistance to evaporation of a garment (RE)”. In most embodiments, the water vapor permeable upper body garment described herein may have a resistance to evaporative heat transfer RET less than of 30 m² Pa/W.

In particular embodiments of the water vapor permeable upper body garment the stretchable functional laminate may comprise a three dimensional configuration. In particular embodiments the first textile layer of the functional laminate may be attached to the first functional film layer by an adhesive layer. Particularly, the adhesive layer of the stretchable functional laminate may form an adhesive pattern including at least two adhesive regions separated by at least one non adhesive region substantially free of adhesive. In one embodiment such functional laminate is described in WO 2014/151223 A1.

Particularly, the stretchable functional laminate may be curled in regions corresponding to the adhesive regions such as to form a visible pattern on the outer surface of the outer shell with bulges formed in regions corresponding to said non-adhesive regions.

Particularly, the stretchable functional laminate may comprises a first functional layer and/or a first textile layer being elastic or configured such as to allow otherwise manipulation to change dimensions (e.g., shrink or elongate). Then, the first functional layer and the first textile layer may be bonded to together by an adhesive layer containing one or more adhesive regions separated by regions substantially free of adhesive. In the adhesive regions, the adhesive may be applied in a discontinuous pattern, e.g. in the form of adhesive dots, to preserve breathability. Alternatively, a water vapor permeable adhesive may be used. The adhesive regions may form at least one distinct shape, particularly a geometric shape, that is repeated two or more time. In case the first textile layer is elastic, the first textile layer may be bonded to the first functional layer such that the laminate bends in the regions substantially free of adhesive. Thereby, raised, visible portions of the laminate corresponding to the unbonded regions are visible on the outer side of the laminate. The raised, visible pattern outlines the distinct shape formed by adhesive regions. In addition the unbonded regions not only relieve the residual stresses in the laminate, they also allow for the introduction of stress (e.g. curl) in the bonded regions without causing excessive curl in the overall laminate. Thereby, the bonded regions may exhibit a localized curling phenomenon. The localized, aggressive curl in the bonded regions, separated by flexible unbonded regions, increases the three-dimensional aspect of the laminate and introduces increased performance and/or characteristics, such as, but not limited to increased insulative properties, stretch, spectral properties, and aesthetic characteristics.

To form a functional laminate comprising a three dimensional configuration, as described above, the first textile layer may stretched a predetermined distance and adhesive may be applied to the first functional film layer in an unstretched, relaxed state. As discussed in detail above, adhesive is applied in a discontinuous, nonuniform manner to provide bonded regions and unbonded regions. While the first textile is tensioned in a stretched position, the first functional film layer containing adhesive is positioned on the first textile layer to bond the first functional film layer to the first textile layer. Upon the release of tension, the first textile layer returns to approximately its original, unstretched position. As the first textile layer relaxes (“unstretches”), the bonded regions curl and the unbonded regions rise. The laminate buckles (e.g., bunches) in the unbonded regions due, at least in part, to the absence or substantial absence of adhesive in the unbonded regions compared to the bonded regions. The terms “buckle” and “bunch” may be used interchangeably herein and are meant to denote the bending of the film layer or textile layer upon itself to form the raised portions. The difference in the presence of adhesive in the bonded regions and the unbonded regions permits the laminate to rise (relax) in the unbonded regions and curl in the bonded regions.

Stretching the first textile layer and first functional film layer may occur in one direction as described above, but bi-axial stretching is possible as well.

Moreover, the stretchable functional laminate may comprise a second textile layer attached to the first functional film layer on its side opposite the first textile layer.

Moreover, the second textile layer being the innermost layer of the functional laminatemay form an inner lining of the upper body garment. Thereby, a “garment” may be created that forms an inner lining by itself.

Particularly, the water vapor permeable upper body garment as described herein may include a waterproof and water vapor permeable functional shell made up with at least one panel of the stretchable functional laminate and at least one panel of a non-stretchable functional laminate comprising a second waterproof and water vapor permeable functional film layer. The panels of stretchable functional laminate and non-stretchable functional laminate may be connected by a liquidproof seam. For example, the liquidproof seam may comprise a seam tape.

Particularly, the panel of non-stretchable functional laminate may comprise flat surfaces.

Particularly, the water vapor permeable upper body garment as described herein may have the configuration of a jacket, a sweater, or a vest.

The invention will be described in more detail in the following by way of exemplary embodiments which are sown in the figures. These show:

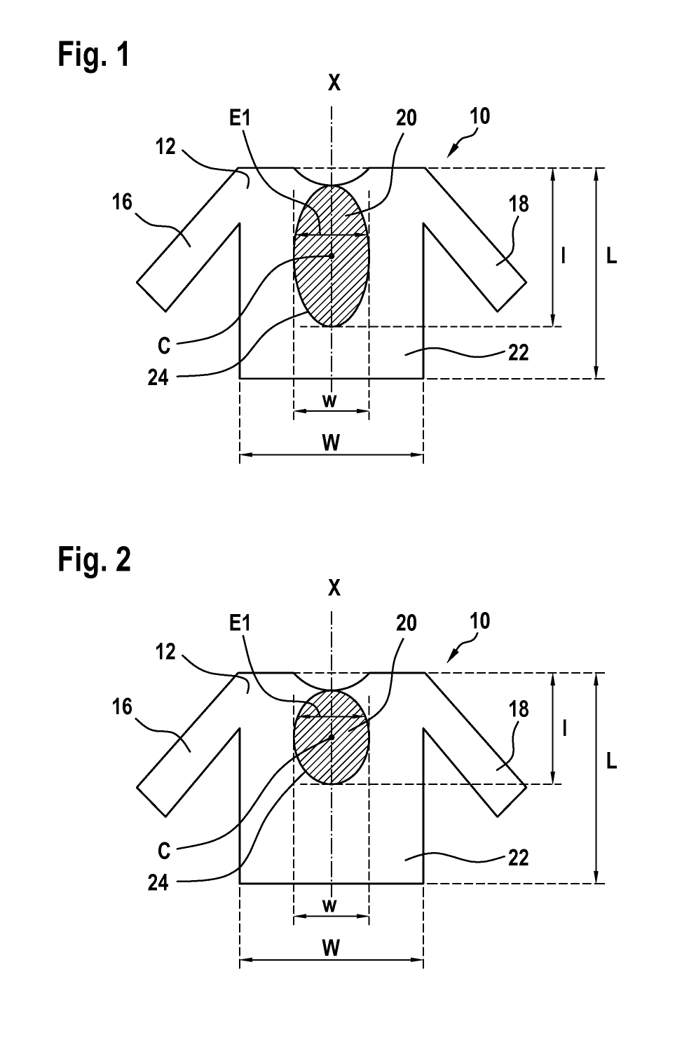

FIG. 1 shows a highly simplified and schematic view of the back side of a water vapor permeable upper body garment according to an embodiment;

FIG. 2 shows a highly simplified and schematic view of the back side of a water vapor permeable upper body garment according to a further embodiment;

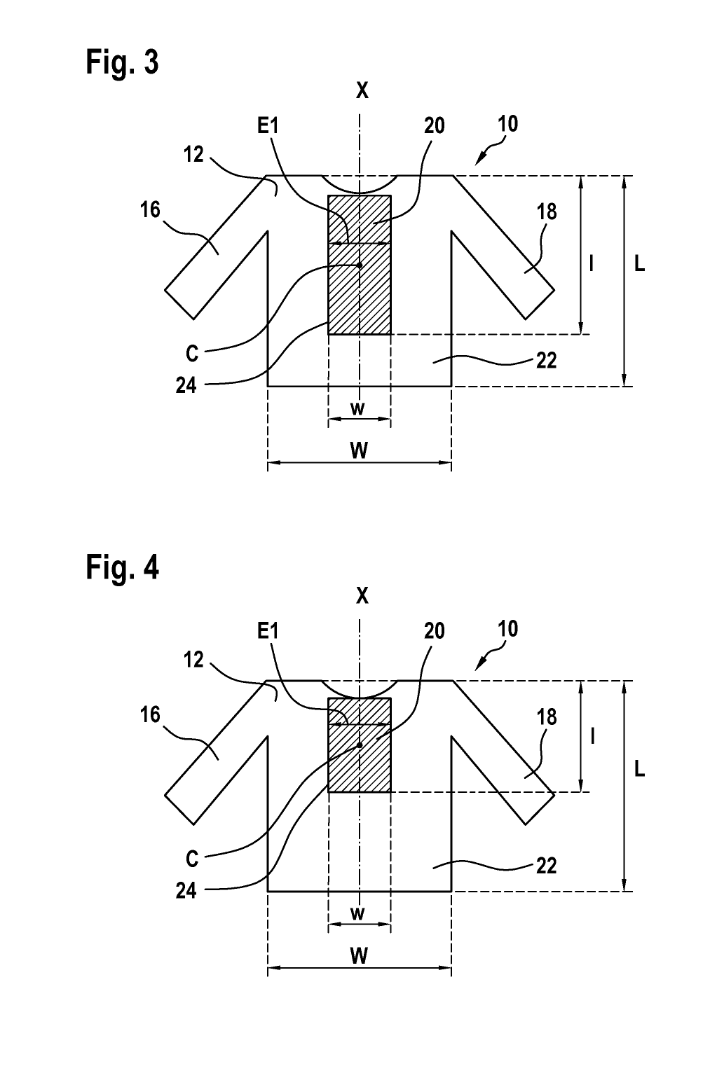

FIG. 3 shows a highly simplified and schematic view of the back side of a water vapor permeable upper body garment according to a further embodiment;

FIG. 4 shows a highly simplified and schematic view of the back side of a water vapor permeable upper body garment according to a further embodiment;

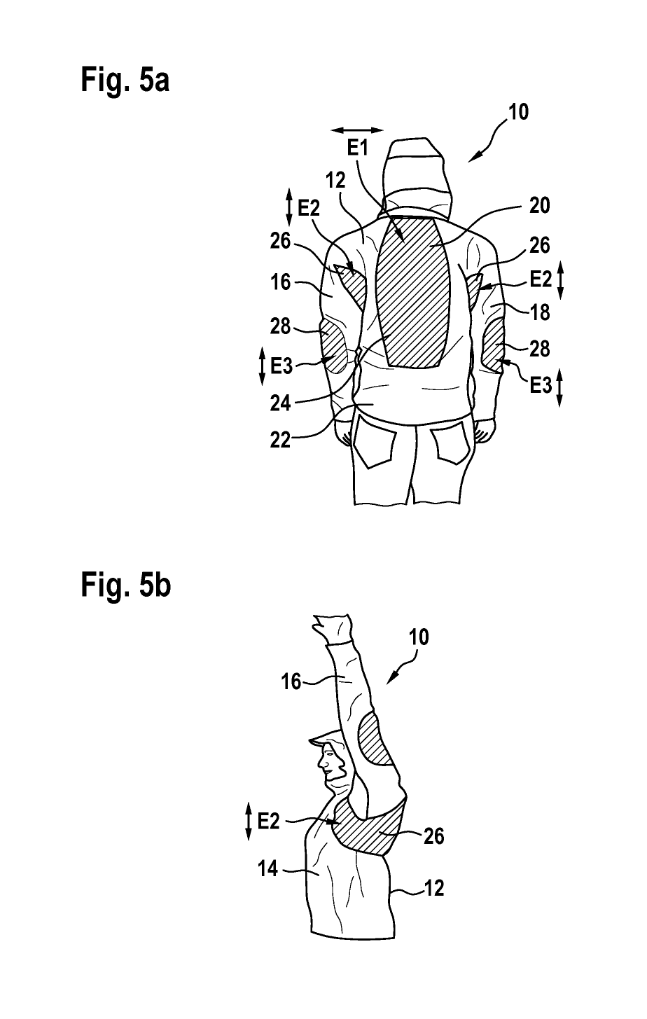

FIGS. 5a and 5b show highly simplified and schematic views the back side and the lateral portion of a water vapor permeable upper body garment according to a further embodiment;

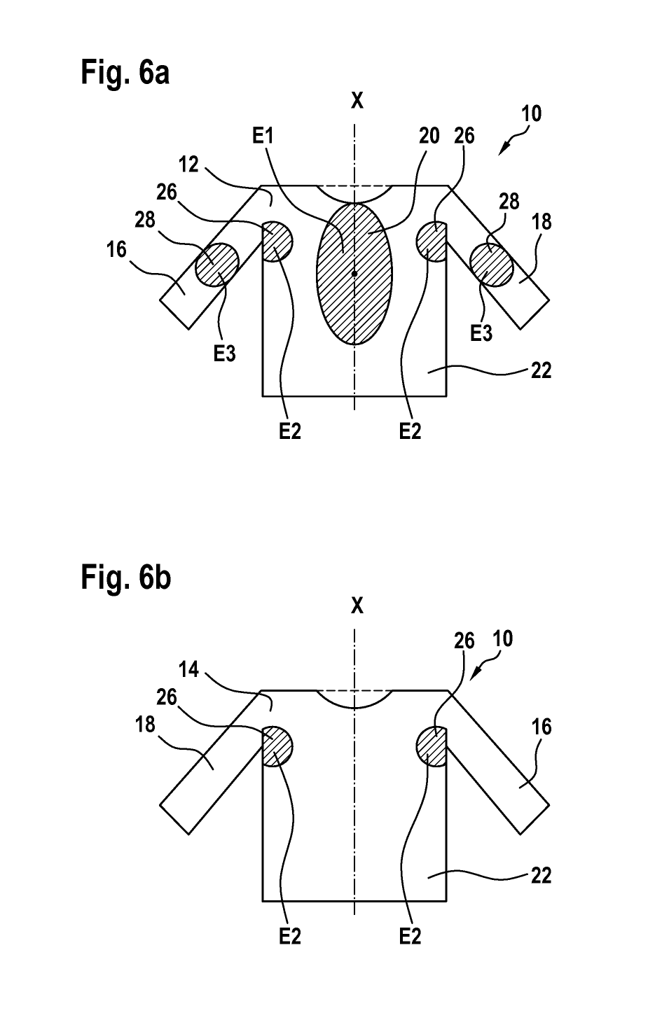

FIGS. 6a and 6b show highly simplified and schematic views of the back side and the front side of a water vapor permeable upper body garment according to a further embodiment; and

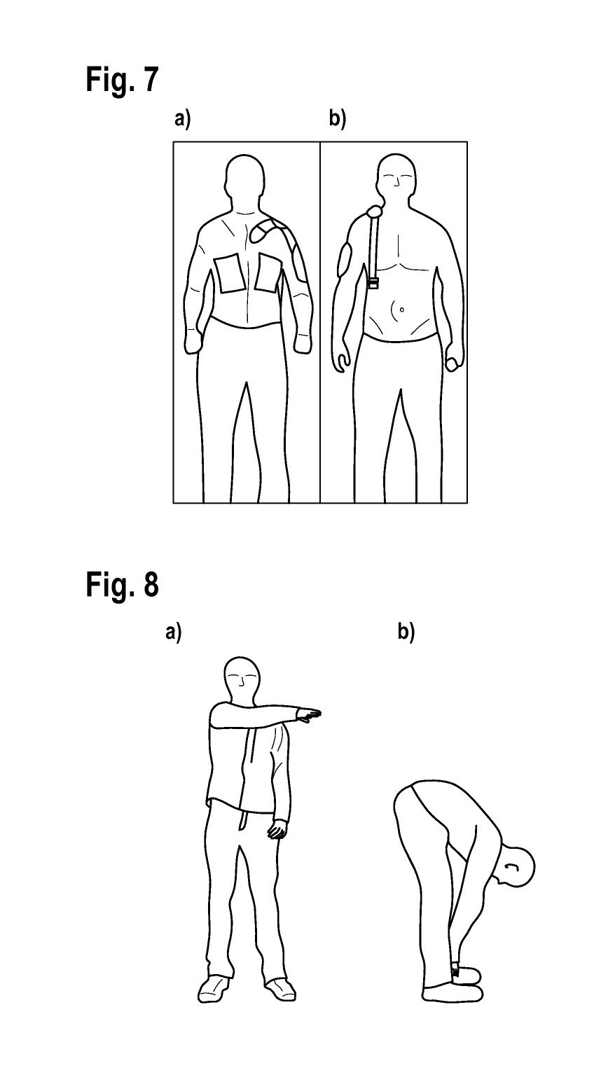

FIGS. 7a and 7b show highly simplified and schematic views of a test person subject to the test procedure to measure garment resistance force of water vapor permeable upper garment, FIG. 7a showing the back side of the test person and FIG. 7b showing the front side of the test person schematically.

FIGS. 8a and 8b show highly simplified and schematic views of the test procedure to measure garment resistance force of water vapor permeable upper garment according to an embodiment.

FIGS. 8 to 11 show schematic illustrations with respect example 1 set forth herein.

FIGS. 1 to 4 show highly simplified and schematic views of a back side 12 of a water vapor permeable upper body garment 10 according to embodiments. The same reference numerals are used for designating the same or corresponding components in the various embodiments shown in FIGS. 1 to 7. It is to be understood that the same description applies to each of these embodiments, unless any differences are set out expressly with respect to a specific embodiment.

The upper body garment 10 comprises the back side 12, a front side 14 (see FIG. 6b), a left arm sleeve 16, and a right arm sleeve 18 (seen from the perspective of a person wearing the upper body garment 10). In the embodiments shown, the upper garment is a jacket. In other embodiments, the upper garment may be a sweater, a vest, or the like. The same description as set out herein with respect to a jacket will apply to such alternative embodiments as well. Embodiments without arm sleeves (e.g. vests) are conceivable as well and the description given herein also applies to such embodiments as well, in particular with respect to the stretchable functional laminate arranged in the upper central portion on the back side 12 of the upper garment 10.

The back side 12 of the upper garment 10 comprises a first panel 20 made from a stretchable functional laminate. The first panel 20 has an elongate shape with a longitudinal axis X thereof extending basically in vertical direction, i.e. parallel to the spinal column of a person wearing the upper body garment 10. The stretchable functional laminate has characteristics as set forth herein. Particularly, the stretchable functional laminate is breathable and waterproof and may have elastic characteristics. The first panel 20 is connected to a basic functional laminate 22 by a waterproof seam 24. The basic functional laminate 22 is made of a non-stretchable functional laminate having breathability and waterproofness characteristics as desired. In the embodiments shown in FIGS. 1 to 4, the basic functional laminate 22 covers the portions of the upper body garment 10 outside the first panel 20. The first panel 20 of stretchable functional laminate covers the upper central portion on the back side 12 of the upper body garment 10. FIGS. 2 and 4 show embodiments where the first panel 20 of stretchable functional laminate has an extension I in longitudinal direction of about 50% of the total length L of the back side 12 of the upper garment 12, measured from the top of the back side 12 of the upper garment downwards (i.e parallel to the spinal column). FIGS. 1 and 3 show embodiments where the first panel 20 of stretchable functional laminate has an extension I in longitudinal direction of more than 50% of the total length L of the back side 12 of the upper garment 12. When measuring the total length L, any neckline of the upper body garment is not considered, as indicated in FIGS. 1 to 4.

Moreover, the first panel 20 of stretchable functional laminate may have a lateral extension w of at least 25% of the total width W of the back side of the upper garment. The first panel 20 is symmetrical with respect to the longitudinal axis X. Hence, the lateral extension w may be measured from the longitudinal axis X and extend 12.5% of the total width W of the back side 12 of the upper garment 10 towards each side in lateral direction. In the embodiments shown the longitudinal axis X of the first panel 20 is located centrally on the back side 12, i.e. extends basically along the spinal column of a person wearing the upper body garment 10. Therefore, the first panel 20 is located centrally on the back side 12 in lateral direction.

Particularly, the first panel 20 of stretchable functional laminate may cover between 25 and 35% of the area of the back side 12 of the upper body garment 10. The centre C of the first panel 20 may be located at around 25% of the length L of the back side 12 of the upper body garment 10, starting from the top of the back side 12. Moreover, the centre C of the first panel 20 of stretchable functional laminate may be located at 50% of the width W of the back side 12 of the upper body garment 10. The length l of the first panel 20 may be between 50% and 70% of the total length L of the back side 12 of the upper body garment 10, measured starting from the top of the back side downwards. The width w of the first panel 20 may be between 25% and 35% of the total width W of the back side of the upper body garment, symmetrical to the central vertical axis X of the back side 12 in lateral direction.

Particularly, the first panel 20 may cover between 5% and 50% of the total surface area of the outer shell of the upper body garment 10, particularly between 10% and 35%, particularly between 15% and 25%.

In the embodiments shown in FIGS. 1 and 2 the first panel 20 of stretchable functional laminate has an oval shape. In the embodiments shown in FIGS. 3 and 4 the first panel 20 of stretchable functional laminate has a rectangular shape.

Other shapes of the first panel 20 of stretchable functional material are conceivable as well, e.g. a triangular shape, a trapezoidal shape, or a more complex shape like the shape of the first panel 20 shown in FIG. 5b which has convex curved lateral edges connected by linear edges on the top and bottom side.

The main direction of stretchability (or elasticity in case of a functional laminate having elastic characteristics) of the stretchable functional laminate forming the first panel 20 is indicated by reference numeral E1 in FIGS. 1 to 6. As can be seen, the main direction of stretchability E1 of the stretchable functional laminate forming the first panel 20 is in lateral direction.

While the embodiments shown in FIGS. 1 to 4 only include the first panel 20 of the stretchable functional laminate, other embodiments may comprise further panels of stretchable functional laminate. E.g. the embodiments as shown in FIGS. 5a/5b and 6a/6b comprise at least one second panel 26 of stretchable functional laminate (in particular two second panels 26) and at least one third panel 28 of stretchable functional laminate (in particular two third panels 28).

The second panels 26 of stretchable functional laminate cover respective lateral portions of the upper body garment 10 connecting the back side 12 and the front side 14. In embodiments which include left and right arm sleeves 16, 18, the second panels 26 may be located below the arm pit of each of the arm sleeves 16, 18, as shown in FIGS. 5a/5b and 6a/6b. The main direction of stretchability E2 of the stretchable functional laminate forming the second panels 26 is directed vertically, as indicated by the double sided arrows designated by E2. The second panels 26 are visible on the back side 12 as well as on the front side 14 of the upper body garment. The second panels 26 may have a generally circular shape or oval shape.

The two third panels 28 of stretchable functional laminate are located on the left and right arm sleeves 16 and 18, in a region at the elbow, respectively. These third panels 28 have a main direction of stretchability E3 along the longitudinal extension of the respective arm sleeve 28, as indicated by the double sided arrows E3. The third panels 26 also may have a generally circular shape or oval shape.

### Test Procedures:

### Suter Test for Liquid-Proof Fabrics

The Suter Test Method was used to determine if a sample was liquid-proof. This procedure is based generally on the description in ASTM D 751-00 (2000), Standard Test Methods for Coated Fabrics (Hydrostatic Resistance Procedure B2). This procedure provides a low pressure challenge to the sample being tested by forcing water against one side of the test sample and observing the other side for indication that water has penetrated through the sample.

The test sample was clamped and sealed between rubber gaskets in a fixture that held the sample so that water could be applied to a specific area. The circular area to which water was applied was 10.795 cm (4.25 inches) in diameter. The water was applied at a pressure of 7 kPa (0.07 bar) to one side of the sample. In testing laminates with one textile layer the pressurized water was incident upon the film side.

The unpressurized side of the sample was observed visually for any sign of water appearing for 3 minutes. If no water was observed the sample was deemed to have passed the test and was considered liquid-proof. The reported values were the average of three measurements.

Rain Tower Test

The rain tower test was used to determine whether a garment is waterproof in a real rain situation. The testing procedure is described in the standard EN 14360 (2004). A mannequin with a standard size of an adult person (1820±40 mm height and 1000±60 mm torso circumference) is placed under a rain tower. The rain tower has a “shower” head of at least 1000 mm circumference. The shower head is placed at least 5000 mm above the ground level. The shower head contains around 682 nozzles with a circumference of 0.6 mm each, in a distance of 34 mm from each other. Therefore, the rain tower should be able to produce a rain density of 1000 drops/m² over a circular area with a total circumference of 932 mm.

During testing, the mannequin wears water absorbent underwear (T-shirt and trousers) under the upper garment (e.g. a jacket). The rain fall time is set at 60 min. Subsequently, the tested upper garment should rest for 2 min on the mannequin before being carefully removed. After the removal of the upper garment, the total wetted area of the underwear is identified and quantified in cm².

For determining waterproofness of an upper garment, at least two samples of the upper garment of the same type should be tested.

### Stretch Force Measurement

Stretch force measurement was carried out following the procedures set out in EN14704-1:2005. The force to elongate of the samples was measured using an Instron universal testing machine (Model 5565) with a 500N load cell. A 50 mm by 100 mm sample of material was cut with the long dimension oriented in the direction of maximum elongation. The ends of the sample were clamped together in the pneumatic clamp grips such that there was neither tension nor slack in the sample and proper alignment of the sample to the traverse direction is maintained. The sample was stretched at a cross-head displacement rate of 100 mm/min to x 300N for the non-elastic laminates/30N for the elastic laminates and retracted to zero displacement (the start position when the experiment started) to complete the hysteresis cycle. This was repeated for three cycles. From the third cycle the load at 20% strain was recorded from the output data file. The reported values represent the average of three measurements. The elastic recovery is expressed in percent in relation to the total amount of elongation put into the sample as shown by the following equation:

$$R = \frac{D}{S} \times 100$$

where,
R=Elastic recovery (%)
D=Recovered elongation
S=Laminate elongation

### Breathability

Breathability is defined as the resistance to evaporative heat transfer provided by a laminate, and is quantified by RET (resistance to evaporative heat transfer) values as described in ISO 11092 (1993).

The ISO 11092 or the RET or Hohenstein test is also called sweating hot plate test. In this test a fabric (e.g. a laminate) is placed above a porous (sintered) metal plate. The plate is heated and water is channelled into the metal plate, simulating perspiration. The plate is then kept at a constant temperature. As water vapor passes through the plate and the fabric, it causes evaporative heat loss and therefore more energy is needed to keep the plate at a constant temperature. RET is the measurement of the resistance to evaporative heat loss. The lower the RET value, the less resistance to moisture transfer is provided by the fabric, and therefore the higher is the breathability of the fabric.

A fabric (e.g. a laminate) is considered breathable in case it has an RET value of 20 m² Pa/W, or lower.

### Measurement of Resistance to Evaporation of a Garment (RE)

The Hohenstein test was modified to measure resistance to evaporation of a garment. Other than a fabric (e.g. a laminate), a garment has a 3 dimensional structure. To allow a sweating hot sample test, similar to the sweating hot plate of the Hohenstein test, a sweating torso test was developed and carried out.

In the sweating torso test for measuring cooling power of personal cooling systems, sweating mannequins are generally used for measuring the evaporative resistance of a garment. The mannequin skin is covered by tight fitting cotton and then wetted, either at the beginning of a test, and/or continually. When the mannequin surface and the test chamber are the same temperature, the electric power required to keep the mannequin surface at constant temperature is detected. This electric power is proportional to the evaporative resistance of the garment. In order to simplify and speed up the test procedure, a specific sweating torso has been built and used to facilitate the testing of prototypes. The sweating torso has a cotton skin. Ten heating pads are attached to the cotton skin of the torso. Eight of these heating pads are controlled such as to remain at a pre-given temperature. The other two heating pads are configured to provide the neck and lower waist of the garment to be tested and serve as guard rings. Two of the heating pads cover the top and bottom portion of the front side of the torso. Two of the heating pads cover the top and bottom portion of the back side of the torso. Two further heating elements may be provided at the two lateral portions of the torso. The other two heating elements are provided at the shoulders of the torso.

During each sweating torso test for measuring cooling power of a garment, the power provided to the torso was controlled in such a way that the surface temperature of the torso is kept at 35° C. The torso is kept in a chamber, generally at 35° C. and 50% relative humidity. The electric power provided to each of the eight heaters has been monitored.

Typically, data from a sweating torso test with respect to a torso and a garment fitted to the torso, are obtained by splitting the heating in 8 zones. The 8 heating zones are designed to cover areas which are differently effected in clothing. Thus e.g. the distribution of the cooling over the torso can be examined. From knowledge of the air flow rate, temperature, and humidity of the inlet air, the difference in enthalpy between the wet torso skin and the inlet air, the maximum theoretical cooling can be calculated and then compared to that measured. The water weight loss at the end of the test can also be measured since the torso is supported on a balance.

Technical data of the test installation were as follows:

Max. heating power 900 W
Max. sweat rate 4800 g/hour
8 heating zones 2 heated guard zones
Balance for recording weight loss

The cotton vest of a mannequin was pre-wetted prior to each test. During the measurement of cooling power, water was supplied at a rate equivalent to the expected cooling power, e.g. 4.6 g/minute was used for cooling powers of about 185 W.

The RE data for the garment comparison were measured by a wind speed of 0.5 m/s and by a temperature of 35° C.

### Garment Resistance Force

The measurement of the garment resistance force was used to determine the force needed by the wearer of the garment to perform standardized movements. The garment resistance force was quantified with the help of 660 capacitive force sensors with an area of 1 cm² each, placed on the back (over the shoulder blades), on the right upper arm and on the shoulder of the test person, as indicated in FIG. 7, FIG. 7a showing the back side of the test person and FIG. 7b showing the front side of the test person schematically. The resistance force [N] of a garment or a garment system is defined as the sum of the force (vertical component, e.g. normal force) values of each sensor at the point of time where the participants reach final amplitude in the performance of the following 2 standardized movements shown schematically in FIG. 8:

(i) Subjects crossing their stretched right arm in front of the body, in a combination of shoulder flexion and adduction, see FIG. 8a).
(ii) The simulation of a shoe lacing situation, see FIG. 8b.

Each movement was repeated three times. The mean force calculated out of these three repetitions resulted in the garment restriction force.

### EXAMPLES

### Example 1 (Stretchable Laminate)

Example 1 is a stretchable functional laminate manufactured as set out in WO2014/151223. Said stretchable functional laminate also demonstrates elastic properties.

A length of 165 g/m² nylon/elastane stretch woven material (Style 544B from Gehring-Tricot Corp., Garden City, N.Y.) and a length of polyurethane-coated ePTFE were obtained. The ePTFE had the following properties: thickness=0.043 mm, density=0.41 g/cc, matrix tensile strength in the length direction=31×10⁶ MPa, matrix tensile strength in the width direction=93×10⁶ MPa, Bubble Point=1.5×10⁵ MPa. Polyurethane (PU) was applied by coating the ePTFE membrane and allowing it to at least partially penetrate the pores of the membrane, then cured.

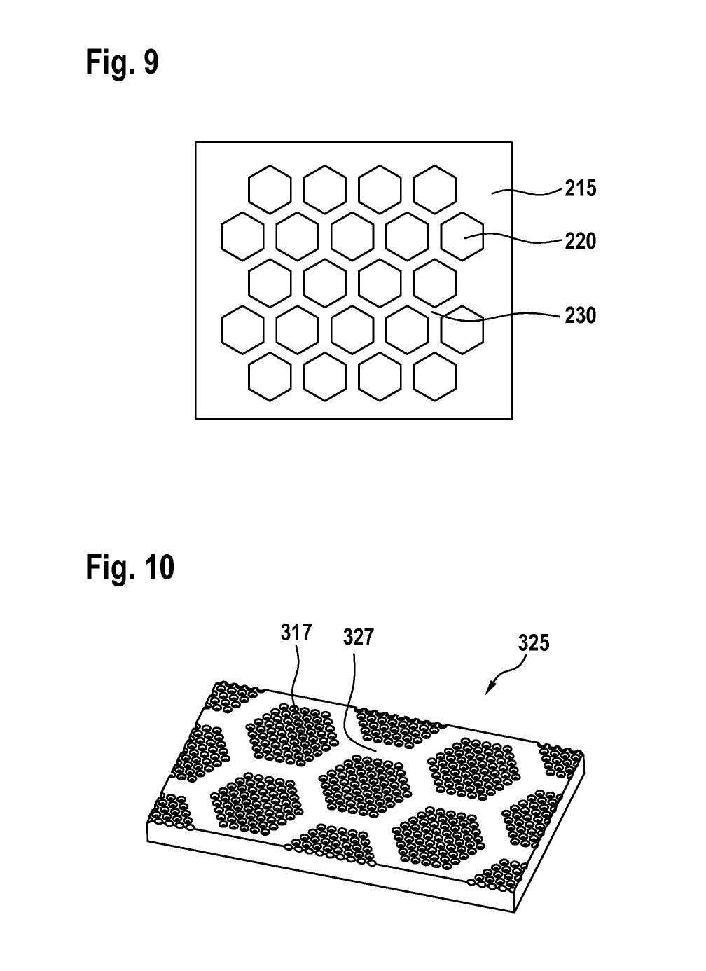

A release paper 215 was laser cut using the honeycomb (hexagonal) pattern shown in FIG. 9. The hexagonal voids 220 were cut 6 mm wide and were separated by 2 mm wide strips 230 of release paper. The release paper was positioned onto the ePTFE side of the coated membrane and the release paper plus membrane were fed into the gravure printer.

Alternatively to the procedure utilized in this example, an alternative procedure could have been used, as shown in FIG. 10. A gravure roll having thereon the applied adhesive pattern (shown generally as reference numeral 317 in FIG. 10) may transfer the adhesive to the functional film layer (e.g., coated membrane), thus eliminating the need for release paper. A portion 325 of the gravure roll 315 is depicted in FIG. 10 and contains both the adhesive pattern 317 and non-adhesive areas 327.

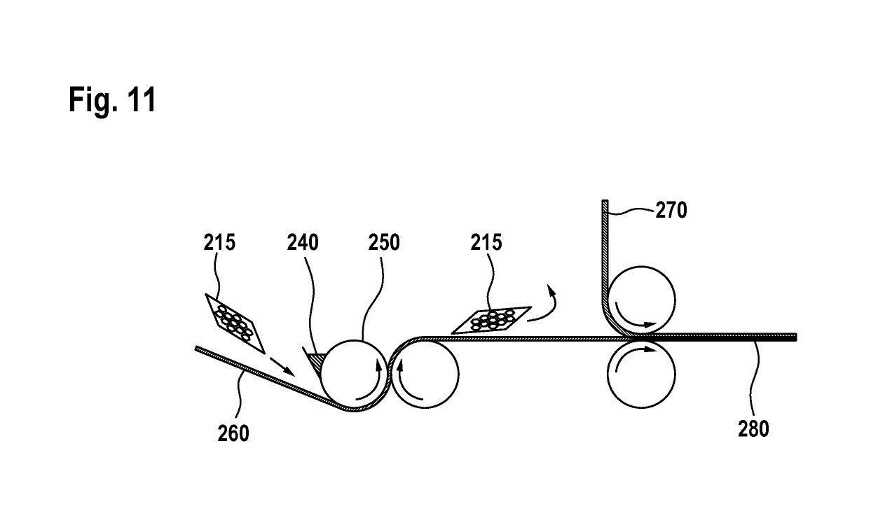

FIG. 11 hows a portion of the processing line for forming a two-layer laminate. Another polyurethane 240 was obtained and loaded in the printer in order to apply heated adhesive dots to the ePTFE side of the membrane via roll 250. 350 micron diameter dots were applied at a percent area coverage of 65% to the unmasked area of the ePTFE membrane 260. As used herein, the term “percent area coverage” of adhesive is meant to denote the total two-dimensional area of adhesive in a given region divided by the area of that region, multiplied by 100%. The stretch woven material was tensioned, the release paper 215 (mask) was removed, and the stretch woven textile 270 was placed onto the adhesive side of the membrane 260. While retaining the tension on the textile 270, the resulting laminate 280 was spooled onto a roll (not shown) and allowed to moisture cure, which required approximately 2 days.

Additional adhesive dots were also applied to the coated side of the ePTFE, and a third layer of textile, a 37.3 g/m² polyester knit (Style A1012 from Glen Raven, Glen Raven, N.C.) was added to the adhesive on the side opposing the nylon woven textile.

Following moisture curing, the laminate was unspooled and allowed to relax, thereby returning to the initial, un-tensioned state of the textile. The hexagonal pattern was visible by the naked eye. The sample exhibited localized curling in the areas corresponding to the hexagonal voids in the release paper. The concave surface of these areas was towards the woven textile side of the laminate.

### Example 2 (Non-Stretchable Laminate)

Example 2 is a non-stretchable laminate.

The non-stretchable laminate is a 3 layer laminate made of a polyurethane-coated ePTFE membrane attached on one side to a woven (plain 1/1) face fabric of 100% polyamide and on the other side to a woven (plain 1/1) backing fabric material. Said laminate is commercially available under the part no SALN000600GA by W.L. Gore & Associates. The non-stretchable laminate has a weight of 75 g/m² and an Ret of 4.5. The sample is water proof and breathable. The non-stretchable laminate shows a stretch to force at 20% elongation of 48N/cm.

### Example 3 (Upper Body Garment)

A garment (jacket) was made combining a non-stretchable functional laminate according to example 2 and panels of the stretchable laminate according to example 1. The garment had a configuration as shown in FIGS. 6a and 6b.

A total of 5 stretchable panels were placed on the garment, as follows:

(i) An oval-shaped first panel was located on the back side of the garment, covering an area of 874 cm² or around 7% of the whole area of the garment. The panel had a maximum length of 53 cm and a maximum width of 21 cm. The center of the panel was located at around 35% of the total length (measured from the top) and at 50% of the total width (along the longitudinal axis the body) of the back side of the garment. This panel had a main direction of stretchability in the horizontal direction.
(ii) Two circular second panels (stretchable area represents ¾ of the total area) were located under the arm pit, one at each side of the jacket, with an area of 462 cm² each (total: 924 cm²) or around 8% of the total area of the garment. These second panels had a main direction of stretchability in the vertical direction.
(iii) Two oval-shaped third panels were located on the elbow, one at each side of the jacket, with an area of 236 cm² each (total: 472 cm²) or around 5% of the total area of the garment. These third panels had a main direction of stretchability in the vertical direction.

The stretchable garment (jacket) had an EU-size 52 and was made in a close fit style according to definition presented in table 1. The garment was conceived as a long-sleeve jacket comprised of a single shell, whereby the single shell was made of the non-stretchable laminate attached to the 5 panels of stretchable laminate by using waterproof seams, according to the Suter test procedure described herein.

### Example 4 (Comparative Garment Made of Non-Stretchable Laminate)

Comparative Example 4 is a garment (jacket) made of the non-stretchable laminate as in example 2. The garment had an EU size 56 (XXL) and was constructed as an outer shell garment with a regular fit (according to values showed in table 1). The garment was constructed as a long-sleeve jacket, completely composed by the laminate as in example 2.

### Example 5 (Comparative Garment Made of Non-Stretchable Laminate)

Comparative Example 5 was a garment (jacket) made of the non-stretchable laminate as in example 2. The garment had an EU size 52 (L) and was constructed as an outer shell garment with a regular fit (according to values showed in table 1). The garment was constructed as a long-sleeve jacket, completely composed by the laminate as in example 2.

### Laminate Comparison:

Table 2 shows a comparison of various characteristics of the laminates according to examples 1 and 2.

TABLE 2

| | Example 1 | Example 2 | |
|---|---|---|---|
| | (stretchable | (non stretchable | |
| | laminate) | laminate | Test method |
| Laminate weight | 267 g/m² | 75 g/m² | ISO 3801, |
| | | | method 5/ |
| | | | EN12127 |
| Ret | 9.6 | <4.5 | EN31092/ |
| (m²Pa/W) | | | ISO11092 |
| Force to elongate | 0.37 N/cm | 48 N/cm | EN 14704-1:2005 |
| at 20% elongation | | | |
| Recovery at 20% | 98% | 94% | EN 14704-1:2005 |
| elongation | | | |
| Liquid-proof | Yes | Yes | EN 20811/ISO |
| (resistance to | | | 811 |
| water penetration | | | |
| (kPa) | | | |

The values depicted in table 2 clearly show the differences in elasticity between the laminates according to examples 1 and 2. While Example 1 is a highly elastic material, easily reaching 20% elongation at very low force values with good recovery values, laminate 2 needs about 100-time higher forces to reach the same level of elongation and does not show the same recovery as laminate 1.

### Garment Comparison:

Table 3 shows a comparison of various characteristics of the garments according to examples 3 to 5.

TABLE 3

| | Comparative | Comparative | | |
|---|---|---|---|---|
| | Example 5 (non- | Example 4 (non- | | |
| | stretchable | stretchable | Example 3 | |
| | garment) with | garment) with | (Stretchable | |
| | regular fit, size | regular fit, size | garment) close fit, | |
| | 52 (L) | 56 (XXL) | size 52 (L) | Test method |
| Re for | 30.1 m² · Pa/W | 40.0 m² · Pa/W | 31.1 m² · Pa/W | Sweating Torso |
| garment | | | | |
| Liquid-proof | Yes | Yes | Yes | Rain tower |
| Freedom of | 112.8 (±17.5) N | 71.0 (12.3) | 53.7 (24.8) | Garment |
| movement (i) | | | | resistance force |
| Freedom of | 205.1 (22.7) | 161.1 (11.1) | 143.1 (38.8) | Garment |
| movement (ii) | | | | resistance force |

The values depicted in table 2 show the functional advantages of using an elastic laminate according to example 1 in a jacket. When comparing the garment including patches of stretchable laminate (example 3) to the garment according to comparative example 5 (non-stretchable garment with size L), both jackets show similar levels of evaporative resistance (garment RE) but the stretchable garment according to example 3 has a clear advantage regarding freedom of movement, with much lower garment restriction force values. On the other hand, when comparing the garment including panels of stretchable laminate according to example 3 to the garment according to comparative example 4 (non-stretchable garment size XXL), both jackets show good levels of freedom of movement, but the evaporative resistance of the garment according to comparative example 5 is much higher compared to the garment including panels of stretachble laminate according to example 3. This effect is attributed to the fact that in the garment according to comparative example 4 bigger air gaps exist, as a consequence of its bigger size. Therefore, a garment including panels of stretchable laminate allows a combination of optimal freedom of movement, due to its elasticity, and low evaporative resistance, due to the closer fit allowed by the elastic materials.

1. A water vapor permeable upper body garment having a front side and a back side,
said upper body garment having the configuration of a single shell garment formed by an outer shell laminate, said outer shell laminate formed at least partly by a stretchable functional laminate;
said stretchable functional laminate comprising a first functional film layer and a first textile layer attached to the first functional film layer, said stretchable laminate having a stretch force at 20% elongation of less than 1 N per cm of width; and
said stretchable functional laminate covering at least an upper central portion on the back side of the upper body garment.

2. The water vapor permeable upper body garment according to claim 1, wherein the upper body garment is waterproof.

3. The water vapor permeable upper body garment according to claim 1, wherein the stretchable functional laminate covers at least 10% of the surface area of the outer shell of the upper body garment.

4. The water vapor permeable upper body garment according to claim 1, wherein the stretchable functional laminate comprises a first panel of stretchable functional laminate covering the upper central portion on the back side of the upper body garment, the first panel having any of an oval shape, a rectangular shape, a triangular shape and a trapezoidal shape.

5. The water vapor permeable upper body garment according to claim 4, wherein the first panel of stretchable functional laminate is positioned laterally such as to cover the spinal column of a person wearing the upper body garment.

6. The water vapor permeable upper body garment according to claim 4, wherein the first panel of stretchable functional laminate is positioned vertically such that a longitudinal axis of the first panel of stretchable functional laminate extends along the spinal column of a person wearing the upper body garment.

7. The water vapor permeable upper body garment according to claim 4, wherein the first panel of stretchable functional laminate has a main direction of stretchability which is oriented in horizontal direction.

8. The water vapor permeable upper body garment according to claim 4, wherein the first panel of the stretchable functional laminate is connected to a further functional laminate by a waterproof seam.

9. The water vapor permeable upper body garment according to claim 4, wherein the first panel covers between 5% and 50% of the surface area of the outer shell of the upper body garment.

10. The water vapor permeable upper body garment according to claim 8, wherein the stretchable functional laminate comprises the first panel covering the upper central portion on the back side of the upper body garment, and at least a second panel covering respective lateral portions of the upper body garment connecting the front side and the back side.

11. The water vapor permeable upper body garment according to claim 10, including two arm sleeves, the second panels located below an arm pit covered by each of the arm sleeves, respectively.

12. The water vapor permeable upper body garment according to claim 1, having the configuration of a close fit garment.

13. The water vapor permeable upper body garment according to claim 1, having a garment resistance force as defined herein of 200 N or lower.

14. The water vapor permeable upper body garment according to claim 1, having a resistance to evaporative heat transfer RET of 30 m² Pa/W or lower.

15. The water vapor permeable upper body garment according to claim 1, wherein the stretchable functional laminate comprises a three dimensional configuration.

16. The water vapor permeable upper body garment according to claim 1, wherein the first textile layer is attached to the first functional film layer by an adhesive layer.

17. The water vapor permeable upper body garment according to claim 16, wherein the adhesive layer of the stretchable functional laminate forms an adhesive pattern including at least two adhesive regions separated by at least one non adhesive region substantially free of adhesive.

18. The water vapor permeable upper body garment according to claim 17, wherein the stretchable functional laminate is curled in regions corresponding to said adhesive regions such as to form a visible pattern on the outer surface of said outer shell with bulges formed in regions corresponding to said non-adhesive regions.

19. The water vapor permeable upper body garment according to claim 1 wherein the stretchable functional laminate comprises a second textile layer attached to the first functional film layer on its side opposite the first textile layer.

20. The water vapor permeable upper body garment according to claim 19, wherein the second textile forms an inner lining of said upper body garment.

21. The water vapor permeable upper body garment according to claim 2, including a waterproof and water vapor permeable functional shell made up with at least one panel of the stretchable functional laminate and at least one panel of a non-stretchable functional laminate comprising a second waterproof and water vapor permeable functional film layer; the panels of stretchable functional laminate and non-stretchable functional laminate being connected by a liquidproof seam.

22. The water vapor permeable upper body garment according to claim 21, wherein the liquidproof seam comprises a seam tape.

23. The water vapor permeable upper body garment according to claim 21, wherein the panel of non-stretchable functional laminate comprises flat surfaces.

24. The water vapor permeable upper body garment according to claim 1, having the configuration of a jacket.
